(19) United States
(12) Patent Application Publication
(10) Pub. No.: US 2018/0270265 A1
(43) Pub. Date: Sep. 20, 2018

(54) System and Method For Assessing Network Security Risks

(71) Applicant: Ola Sage, Slver Spring, MD (US)

(72) Inventor: Ola Sage, Slver Spring, MD (US)

(21) Appl. No.: 15/153,894

(22) Filed: May 13, 2016

(51) Int. Cl. H04L 29/06

(52) U.S. Cl. CPC H04L 63/1433; H04L 63/1425; H04L 63/20; H04L 63/1441; H04L 63/102

(57) ABSTRACT

A method for the assessment of an entities vulnerability to a cyber attack is disclosed that includes the steps of creating a current profile for the entity based upon preselected selected risk factors, conducting a risk assessment of said entity based upon said risk assessment profile to create a risk profile which calculates a plurality of risk values; selecting a target profile based upon said current profile of said entity, said target profile further comprising a target risk profile, said target risk profile further comprising a plurality of values, comparing said risk profile with said target risk profile, calculating the differences in said risk values calculated in said risk profile creation step with predetermined values in said target risk profile, wherein said method is performed on a computing device to receive input and, in responses to said input, providing an output based upon predesignated instructions, and said output further comprises a graphic display that includes a representation of values calculated in the risk profile creation step and the target risk profile

The Applicant claims the benefit of U.S. Application No. 62/161,153 filed on May 13, 2015. This invention relates to a system and method to identify, assess and quantify the relative risks of compromising confidential data that is stored by enterprises within networks and computer systems as well as the risk of other interference to an organizations network and systems.

The increasing dependency upon information technology systems and networked operations is present throughout our society. While bringing significant benefits, this dependency can also create vulnerabilities to cyber-based threats or other data loss. Underscoring the importance of safeguarding critical information and information systems and weaknesses in such efforts, federal information security and protecting computerized systems supporting our nation's critical infrastructure are designated as a high-risk area.

Both Federal agencies and private organizations have significant weaknesses in assessing and controlling risk associated with personnel, processes and technology and in particular with information security controls that continue to threaten the confidentiality, integrity, and availability of critical information and information systems used to support their operations, assets, and personnel. For example, in 2011 18 of 24 major federal agencies indicated that inadequate information security controls were either material weaknesses or significant deficiencies. Most major federal agencies have weaknesses in most of the five major categories of information system controls:
access controls, which ensure that only authorized individuals can read, alter, or delete data;
configuration management controls, which provide assurance that only authorized software programs are implemented;
segregation of duties, which reduces the risk that one individual can independently perform inappropriate actions without detection;
continuity of operations planning, which helps avoid significant disruptions in computer-dependent operations; and
Agency-wide information security programs, which provide a framework for ensuring that risks are understood and that effective controls are selected and implemented.

The private sector also has weaknesses with respect to the identification of cybersecurity risks as well as tools, system and processes to mitigate such risks. Not only is there a risk of downtime of the systems, the data itself may be lost by the holder and confidential, sensitive and may be accessed and used by unauthorized users. Before any large organization, governmental or private, takes steps to address deficiencies with respect to their existing systems and system controls, it is helpful to address the nature and significance of the threats. However there remains a need for tools to help decision makers and management to assess the current landscape of their particular organization, the nature of their particular risk. Further, this assessment can provide easy to understand n be

There are existing tools that have been disclosed that are designed to assess the risk of data breaches. For example the patent to Lee, U.S. Pat. No. 8,893,281 discloses a system and methods for the collection of sensitive information within a network of computers regarding the distribution of documents and then calculates the impact of a cyber security incident for a given computer.

The patent to Datta Ray, et al. U.S. Pat. No. 8,856,936 discloses a security, integrity, and reliability postures of operational (OT), information (IT), and security (ST) systems and underlying security and operational blueprint, policies, processes, and rules that govern the enterprise security and business risk management process. The system reportedly can dynamically evolve and adapt to domain, context, and situational awareness, as well as the controls implemented across the operational and information systems.

The nature of the problem and approaches to identify assess and mitigate risks associated with computer networks have been extensively reported upon in the following publications: Tashi et al., “Information Security Management is not only Risk Management”, 2009, IEEE Computer Society, pp. 116-123; Clark et al., “Strata-Gem: Risk Assessment Through Mission Modeling”, Oct. 27, 2008, ACM, pp. 51-57; “Recommended Security Controls for Federal Information Systems”, National Institute of Standards and Technology, U.S. Dept. of Commerce, Special Publication 800-53 Revision 3, August 2009, 237 pages; Chang, Naehyuck, “Concept of Logic Synthesis”, Computer Systems Design, Seoul National University, Presentation, October 2007, 41 pages; Kumar, R. et al., “Induced Chaos for an Agile Smart Grid”, IEEE PES Innovative Smart Grid Technology Conference, Washington D.C., January 2012, 4 pages; Mell, P. et al., “The Common Vulnerability Scoring System (CVSS) and Its Applicability to Federal Agency Systems”, Nat'l Institute of Standards and Technology, U.S. Dept. of Commerce, NIST Interagency Report 7435, August 2007, 33 pages; Ryan, D. J. et al., “Risk Management and Information Security”, Presented at the 11th Computer Security Applications Conference, New Orleans, La., retrieved online from url: http://www.julieryan.com/riskmgt.htm, December 1995, 6 pages; Stoneburner, G. et al., “Risk Management Guide for Information Technology Systems”, National Institute of Standards and Technology, Technology Administration, U.S. Dept. of Commerce, Special Publication 800-30; Recommendation of the National Institute of Standards and Technology, July 2002, 55 pages.

While there is extensive literature and advice to assists persons that are responsible for risk management, there remains a need for practical and effective risk assessment tools to allow users to assess their risk exposure and financial liability in order to implement best practices and to better manage as well as reduce risk exposure. Because of the complex nature of the performing risk assessment and the numerous unique variables that relates to the particular risk of each enterprise, the formulation of appropriate, economical and effective responses and remedial steps are difficult to identify and implement. Accordingly, an object of the present invention is to provide risk intelligence assessment techniques and a risk management application, methods, processes and devices that can assist responsible users with the identification and assessment of risks to networks, such as data breaches, with respect to enterprises as well as assess the relative risk of other potential interference with access and control of a particular network.

An object of the present invention is therefore to provide a system and method that can be used to assess, qualify and quantify the risk associated with networks and other company processes by identifying, collecting and creating relevant data, and then analyzing the nature and extent of the particular risks associated with a particular network and company process and procedures. The system can be used with organizations that have a variety of assets, including in both business and government environments, and can take into account different organization governance structures. A further object of the invention is to provide a system and method to assess and implement the voluntary Critical Infrastructure Cyber Security Framework (“Cyber Framework”). Version 1 of the Cyber Framework was released by the National Institutes of Standards and Technology (“NIST”) in February 2014 which is incorporated by reference herein. A further object of the invention is to provide a customers with an assessment tool to evaluate their readiness and ability to protect their organization from a cyber attack and effectively respond in the event of such an event.

### SUMMARY OF THE INVENTION

The present invention is directed to systems and methods that identify a plurality of risk categories, evaluate the respective risks, and then provide a qualification of those risks. In a preferred embodiments, the system and method is implemented on a computer that has a series of data input screens and screen displays that present various visual displays of the respective risks including displays by preselected categories and the comparison of the calculated risk to a target or aspirational goal. The assessment system of the invention employs a survey to collect data that, in embodiments, is specially catered to identify and assess cyber security risk in a wide number of enterprises across different industries. It then then provides a risk assessment analysis based upon the data entered by the user and historical benchmarks. The data collected in a survey from the user the includes information relevant to inter alia the nature of the assets in the network, the systems used by enterprise, the respective business environment, the governance of the organization, the current risk assessment of threats, the business impact of such threats to the industry, the risk management strategy, various access control information such as the number, the identities and credentials required for authorized devices and users, the training and awareness of users, data security, information protection processes and procedures, maintenance of the system, protective technology, detection of anomalies and events, security monitoring, event and breach detection processes, communications and communication protocols established in response to security related events, analysis of events, the location of users, and the nature of data that is stored on the network. A user of the assessment tool can create a particular project by providing input data with respect to a plurality of preselected data fields with criteria that relates to the respective cyber security risk. Next, based upon user input relating to the various risk related information, the system applies predetermined algorithms to assign values to the various data categories. The system then provides output in the form of custom reports that may be used to measure and assess respective cyber security risks that can help shape remedial actions to improve cyber security including visual displays that can be easily interpreted by the user.

### BRIEF DESCRIPTION OF THE DRAWINGS

FIG. 1 is a schematic representation of computer network computer on which the system and method of the invention may be implemented.

FIG. 2 is a screen display depicting a high level dashboard for the system.

FIG. 3 is a screen display depicting an expanded view of the dashboard of FIG. 3 further illustrating a drop down menu.

FIG. 4 is a screen display depicting a Guide Me Wizard pop-up display.

FIG. 5 is a schematic representation of a computer on which the system and method of the invention may be implemented.

FIG. 6 is a screen display depicting a screen display for entry of data for the user setup step of the invention.

FIG. 7 is a screen display depicting data filed for the set-up step.

FIG. 8 is a screen display depicting a portion of a user survey used in a further step of the invention.

FIG. 9 is a screen display depicting a gap analysis display.

FIG. 10 is a screen display depicting a summary of sub-categories determined to be deficient for a particular user.

FIG. 11 is a screen display depicting an aspect of the Risk Assessment step.

FIG. 12 is a screen display depicting an exemplary data entry page for the user current assessment directed to risk categories relating to the Identify category.

FIG. 13 is a screen display depicting an exemplary data entry page for the user current assessment directed to risk categories relating to the Protect category.

FIG. 14 is a screen display depicting an exemplary data entry page for the user current assessment directed to risk categories relating to the Detect category.

FIG. 15 is a flow chart depicting an embodiment of the method of the invention.

FIG. 16 is a flow chart depicting a series of steps relating to the identification and entry of data relative to cyber security risk.

FIG. 17 is a screen display depicting the

FIG. 18 is a screen display depicting the gap analysis

FIG. 19 is a screen display depicting the gap analysis

### DESCRIPTION OF SPECIFIC EMBODIMENTS

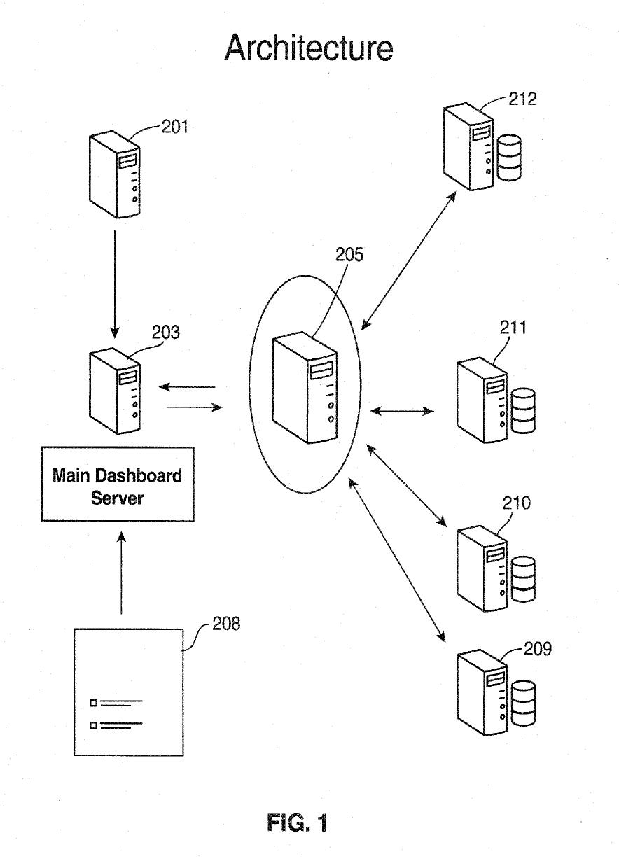

Specific embodiments of invention including systems and methods in which to implement the invention are described herein. FIG. 1 depicts a schematic illustration of exemplary architecture in which the risk assessment process may be implemented. Referring now to FIG. 1, central server 205 is in communication with a dashboard server 203 that allows access by a user's computers 212. Server 205 displays a dashboard to the user and the user can enroll in the Service as well as provide input data relevant to the risk assessment. Server 205 is also in communication with a plurality of additional client computers 209, 210 and 211. The Service Provider can provide input to the central server using computer 201. The Service Provider can also capture data input associated with each User by accessing the database 208 which receives data from the server. Computer 203 takes data and applications from the main dashboard server and database 208 and makes it available on the server. In embodiments, the system may have different access privileges for different categories of users. For example, some users may have different privileges to enable which enable them to read, write create or delete risk data and related data structures within the system. A “manage roles” function is provided that allows an administrator to add or delete user roles, alter privileges associated with roles and edit permissions associated with user roles. In embodiments the roles include administrator, Project Manager, Auditor and Tester and each role is correlated with its own access permissions. In embodiments, the system can manage and segregate data sets based upon locations, including office buildings, data centers and other location were IT assets may be stored.

In operation, according to a first embodiment the user can access a series of data input screens that are made accessible on either a cloud or remote platform or may be provided on a software application that the user can operate on a local processing device. To gain access to the application an account must first be created wherein a user enters, arranges for payment or proves a credit for the system and creates a unique user ID and password.

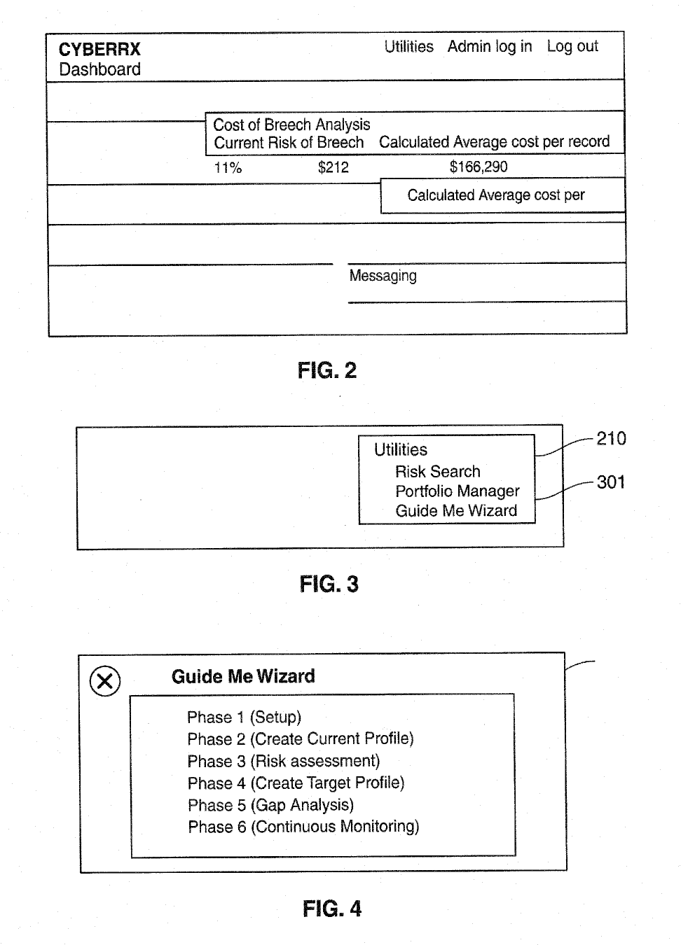

Referring Now to FIG. 2, after an account has been created a dashboard 202 is displayed that communicates information inter alia relating to the estimated costs of breach of the particular system based upon user input. The user may select additional functions from the drop down menu including “risks” 201, Cyber Management 204, reports 206 and resources 208. In addition, the user can select a utilities function 210, administrative functions 212, a user settings 203 and logout 2014 functions. FIG. 2 also displays data from an exemplary client 105 that includes calculated information relating to the client's relative risk of breach exposure 109 and financial liability data 110 that is associated with a breach that includes data for liability per record and liability for each breach 116. The screen display of FIG. 2 further allows access to “Gap Analysis” function 145 including a radar analysis discussed herein. Referring now to FIG. 3, to provide initial base line risk assessment data, the user can select the “Guide Me Wizard” function 311 from the utilities drop down menu 201. As seen in FIG. 4 the Guide Me Wizard includes and allows access to the Phase 1 set up function 401, the Phase 2 create current profile function 403, the Phase 3 Risk Assessment application 405, the Phase 4 Create Target Profile function 407, a Phase 5 Gap Analysis function 409 and Phase 6 Continuous Monitoring Function 410.

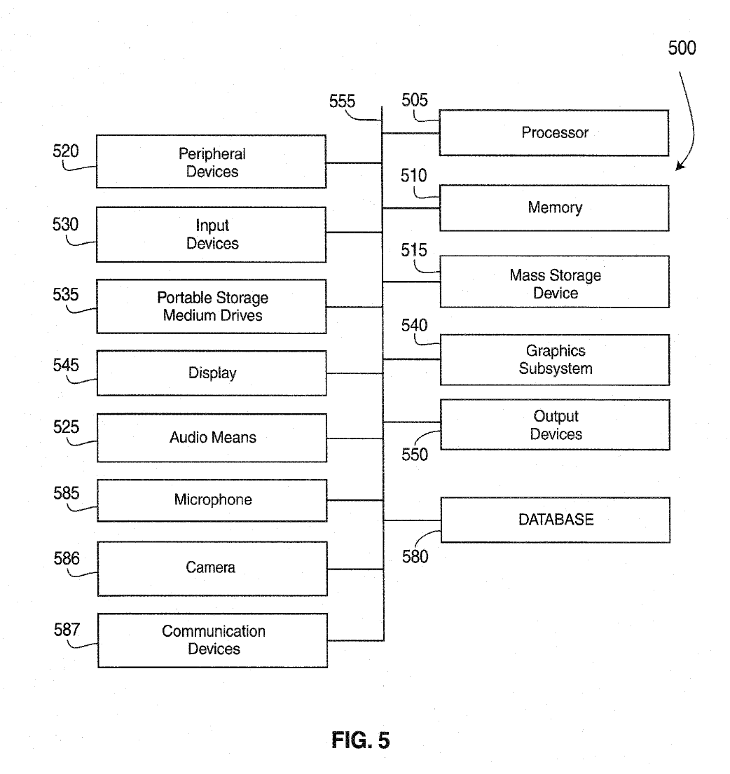

Now referring to FIG. 5, in an embodiment the device is implemented on a computer that includes a display 545, a processor 505, and an input device 530 such as a keyboard, a memory 510 and network access device 587. The computer processor also includes a power source. Referring to FIG. 5, within data processing apparatus 500, an operating system comprises program instruction sequences that provide a platform for the methods described above. The operating system provides a software platform upon which application programs may execute, in a manner readily understood by those skilled in the art. The data processing apparatus 500 further comprises one or more applications having program instruction sequences according to functional input for performing the methods described above.

The data processing apparatus 500 incorporates any combination of additional devices. These include, but are not limited to, a mass storage device 515, one or more peripheral devices 520, a loudspeaker or audio means 525, one or more input devices 530 which may comprise a touchscreen, mouse or keyboard, one or more portable storage medium drives 535, a graphics subsystem 540, a display 545, and one or more output devices 550. The input devices in the present invention may include an RFID detector, a cellular modern, and a magnetic card reader. The various components are connected via an appropriate bus 555 as known by those skilled in the art. In alternative embodiments, the components are connected through other communications media known in the art. In one example, processor 505 and memory 510 are connected via a local microprocessor bus; while mass storage device 515, peripheral devices 520, portable storage medium drives 535, and graphics subsystem 540 are connected via one or more input/output buses.

In embodiments, computer instructions for performing methods in accordance with exemplary embodiments of the invention also are stored in processor 505 or mass storage device 515 or may be provide on the server 205. The computer instructions are programmed in a suitable language such as C++.

In embodiments, the portable storage medium drive 535 operates in conjunction with a portable non-volatile storage medium, such as a CD-ROM, or other computer-readable medium, to input and output data and code to and from the data processing apparatus 500. In some embodiments, methods performed in accordance with exemplary embodiments of the invention are implemented using computer instructions that are stored on such a portable medium or are downloaded to said processor from a wireless link. Peripheral devices 520 include any type of computer support device, such as a network interface card for interfacing the data processing apparatus 500 to a network or a modem.

Still referring to FIG. 5, the graphics subsystem 540 and the display 545 provide output alternatives of the system including the dashboard. The graphics subsystem 540 and display 545 include conventional circuitry for operating upon and outputting data to be displayed, where such circuitry preferably includes a graphics processor, a frame buffer, and display driving circuitry. The display 545 may include a cathode ray tube display, a liquid crystal display (LCD), a light emitting diode display (LED) or other suitable devices. The graphics subsystem 540 receives textual and graphical information and processes the information for output to the display 545

In embodiments, instructions for performing methods in accordance with exemplary embodiments of the invention are embodied as computer program products. These generally include a storage medium having instructions stored thereon used to program a computer to perform the methods disclosed above. Examples of suitable storage medium or media include any type of disk including floppy disks, optical disks, DVDs, CD ROMs, magnetic or optical cards, hard disk, smart card, and other media known in the art.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention. For instance, the Database may not be in proximity to the processor and the processor may communicate remotely with the database. In other contemplated embodiments, other data relating to a particular customer may be located, downloaded and displayed from the Internet.

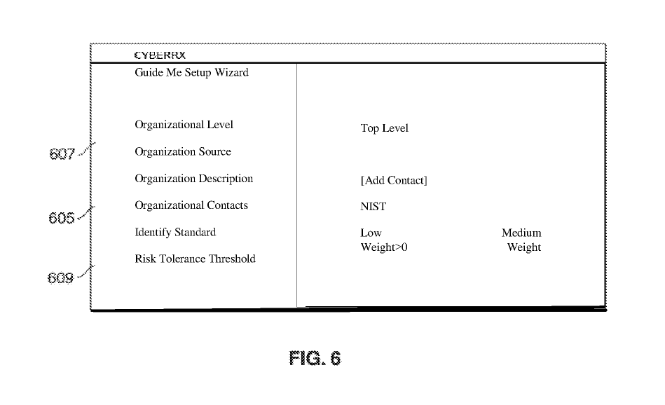

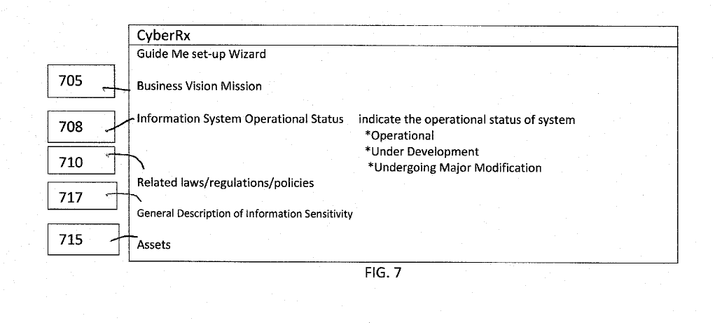

Referring now to FIG. 6, in Phase 1 as discussed above, as part of the set-up wizard, the user can select this option to enter information relating to the user organization including the name 601, the organization's Risk Approach 605, such as NIST or COBIT, Points of Contact 607 of key personnel, and the ability to add Particular Risk Thresholds to each portfolio level 609. COBIT refers to Control Objectives for Information and Related Technology and is a framework that was created by ISACA for information technology management and IT governance. The framework was created to assist managers with the control of systems as they relate to the management of business risks.

Referring to FIG. 7 the Phase 1 Setup continues and the user is prompted to provide information in data fields for the business vision or organizational mission 705, the current operational status of information systems used by the organization 708 which, in embodiments includes a menu of choices. In addition, the user is prompted to enter information regarding the relevant laws regulations and policies that govern the organization in field 710, and to provide a general description of the information sensitivity from the perspective of the particular user 712. The data input screen in FIG. 7 further provides a link to the asset identification exercise 715 as discussed below.

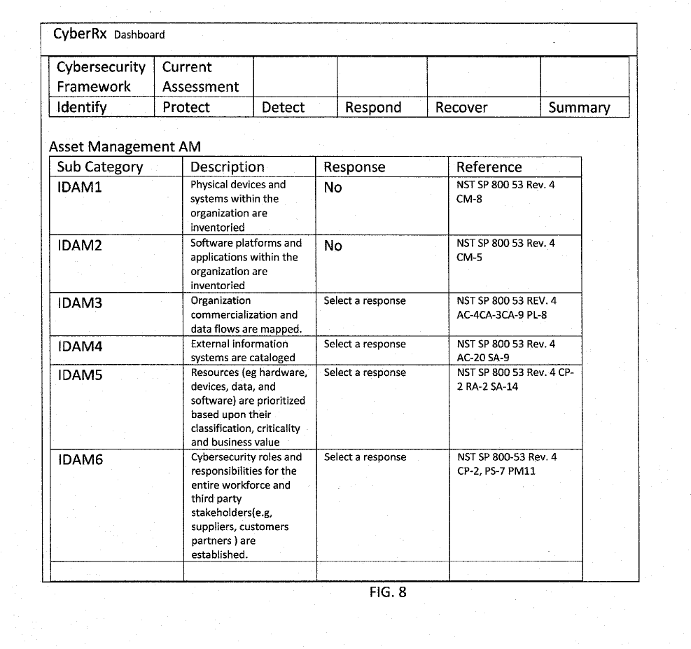

Now referring to FIG. 8, in order to facilitate the identification of assets in the profile, the user is presented with a survey that presents a series of descriptions 805, 807 and 808 each of which a response must be entered in column 810. For each asset, an informative reference standard is cited in column 819. A complete list of the data fields that are presented in this identification stage are provided in Appendix A under the “identification function” and the list includes the identification of physical devices such as computers, tablets, mobile devices, software platforms and applications that are run by the organization, communication data flows and other information that has been identified by NIST or other bodies. In embodiments, some of these identification steps can be implement or assisted by using automated software management tracking software applications (SMTS).

The identification step of Phase 2 of the Setup wizard, located in the Utilities menu of the dashboard, (Create Current Profile) the requires the user to provide information relating to asset management, the business environment, governance, risk assessment and rick strategy Appendix A also identifies a four tiered risk rating for each subcategory which may be high medium or low. The user must answer all applicable questions for each category in each functional area. Accordingly, using the survey during this phase the user also provides input relating to the identification, feature, the detect feature and recover functions. The user is prompted to save the data after completing each page or screen display of the survey. In embodiments, if the data set entered is incomplete, the user is not permitted to proceed to the next data entry region.

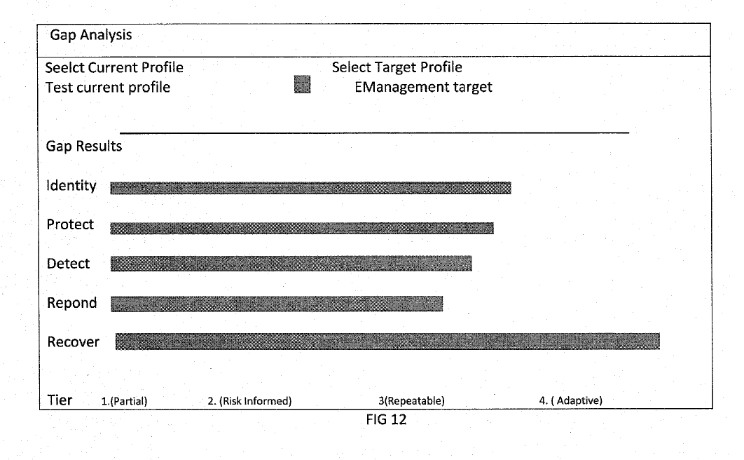

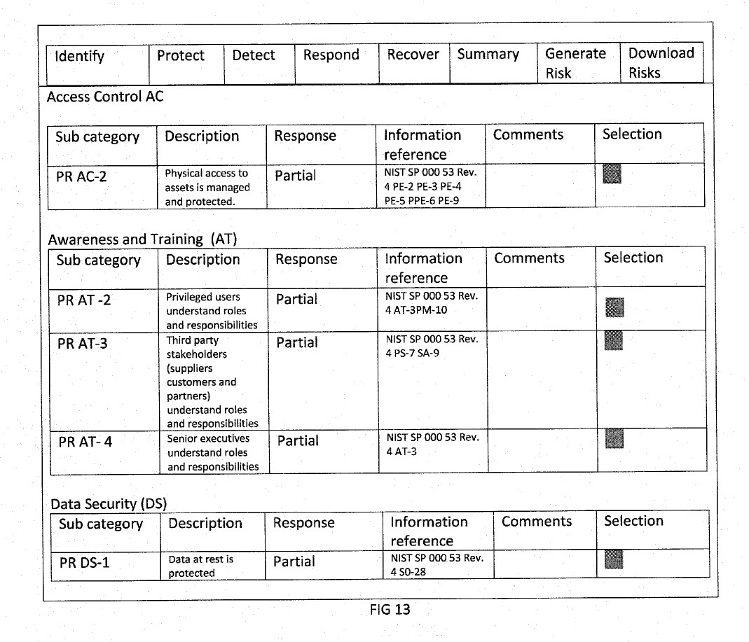

A user proceeds enters data as it relates to the organization for each of the following five functions: identification, protection, detect, respond to complete the organization profile. This information is saved and may be periodically updated to reflect the current status of the organizations cyber security risk. The current assessment requires the user to enter information based upon a survey that includes a plurality of questions relating to various risk. The user must provide an answer to the question in order to generate a current assessment. The response may be that the organization address the risk, does not address the risk, partially address the risk or the risk is not applicable. Exemplary screen displays of survey categories are illustrated in FIGS. 12-14.

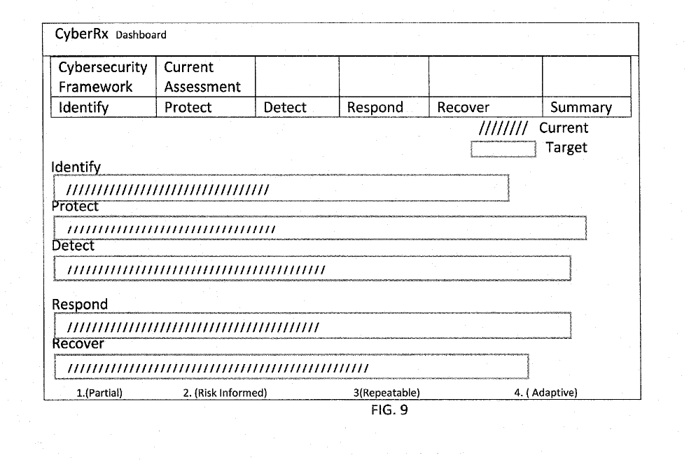

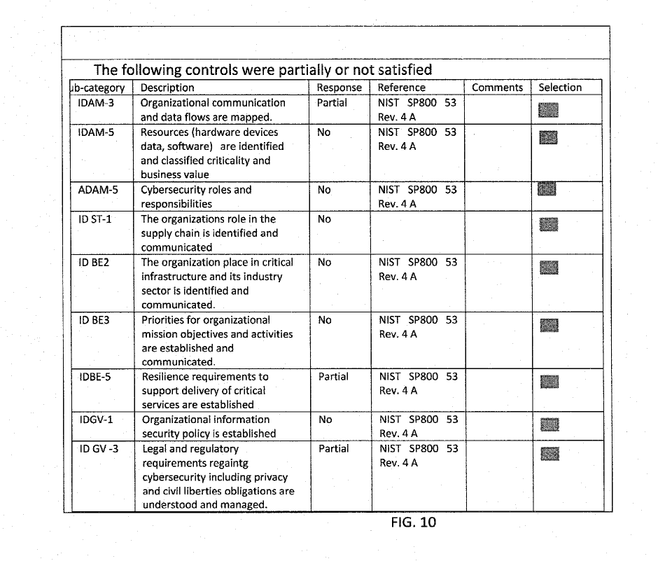

Now referring to FIG. 9, a gap analysis is displayed that includes a summary of the organization's profile as measured by the cyber security Tier levels as defined by the cybersecurity framework is calculated and displayed. The Tiers are further defined below. The display includes a display of data relevant to each of the five functions, identify 905, protect 907, detect 909, respond 911 and recover 913. These values are displayed a bar graph that also communicates the target values 920 and the respective risk profile in the following tiers “partial” 930, “risk informed”932, “repeatable” 934 and “adaptive” 936. Using the summary screen at FIG. 10, the various subcategories 1015 that were determined to be deficient are displayed so management personnel can identify those area that may require remedial efforts. This display in includes a description 1016, the response 1017 and the respective standards 1018 that provides guidance with respect to the risk. In embodiments the user can further generate risk from the subcategories that were determined to be deficient or export such risk data into a separate files for subsequent use.

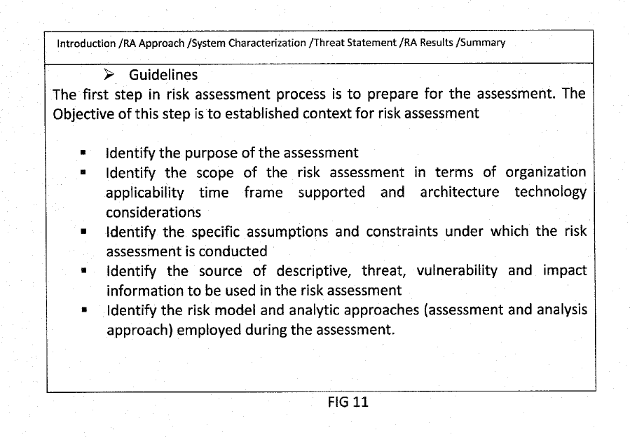

In a further phase or step, the user can assess the respective risks of the organization. After the organization's current cyber profile has been created, the system can be prompted to display screen illustrated at FIG. 11 to initiate the risk assessment phase. As shown in FIG. 11, the risk assessment phase includes guidelines that allows the user to provide context for the respective risk assessment provides data based upon preselected data categories to identify: (1) the purpose of the assessment 1104, (2) the scope of the assessment in terms of organizational applicability, time frame supported and system architecture considerations 1106; (3) the identification any assumptions and constraints under which the assessment is conducted 1108; (4) the identification of the sources of description data, threats, vulnerabilities, and impact information that will be used in the risk assessment exercise 1110; and (5) the identification of the risk mode and analytic approaches that will be employed during the assessment 1112. In embodiments of the invention, hyperlinks are provided to allow users to access additional relevant information relating to the risk assessment module. In response to a user command a risk assessment is performed. The risk assessment step in the setup wizard includes an introduction to the assessment, the approach, a system characterization, a threat statement the Risk Assessment result and a summary. The first step in the risk assessment process is to prepare for the assessment. The objective of this step is to establish a context for the risk assessment. Next the process allows the user to identify the purpose of the assessment.

The purpose of the identification step allows the user to identify the purpose of the risk assessment in terms of the information that the assessment is intended to produce and the decisions the assessment is intended to support. The purpose of the risk assessment is influenced by whether the assessment is: an initial assessment; or a subsequent assessment initiated from the risk response or monitoring steps in the risk management process. For initial assessments, the purpose can include, for example: (i) establishing a baseline assessment of risk; or (ii) identifying threats and vulnerabilities. For a reassessment initiated from the risk response step, the purpose can include, for example, providing a comparative analysis of alternative risk responses or answering a specific question (see discussion of targeted risk assessments above

Next, the scope of the risk assessment is identified in terms of organizational applicability, time frame supported, and architectural/technology considerations. In addition, the specific assumptions and constraints under which the risk assessment is conducted. Further, the sources of descriptive, threat, vulnerability, and impact information to be used in the risk assessment are identified. Finally, the risk model and analytic approaches (i.e., assessment and analysis approaches) to be employed during the assessment.

The risk assessment approach guidelines include (1) Identification of threat sources that are relevant to organizations; (2) Identification of threat events that could be produced by those sources; (3) Identification of vulnerabilities within organizations that could be exploited by threat sources through specific threat events and the predisposing conditions that could affect successful exploitation; (4) Determining the likelihood that the identified threat sources would initiate specific threat events and the likelihood that the threat events would be successful; (5) the determination of adverse impacts to organizational operations and assets, individuals, other organizations, and the Nation resulting from the exploitation of vulnerabilities by threat sources (through specific threat events); and. (6) the determination of information security risks as a combination of likelihood of threat exploitation of vulnerabilities and the impact of such exploitation, including any uncertainties associated with the risk determinations.

In connection with the System Characterization steps in the risk assessment the system and method are directed to identify and characterize threat sources of concern, including capability, intent, and targeting characteristics for adversarial threats and range of effects for non-adversarial threats. For adversarial threat sources, an assessment is made to assess the capabilities, intentions, and targeting associated with the threat sources. For non-adversarial threat sources, the system is intended to assess the potential range of effects from the threat sources. In addition, the system and method assist with the identification of potential threat events, the relevance of the events, and the threat sources that could initiate the events. Threat events are characterized by the threat sources that could initiate the events, and for adversarial events, the TTPs used to carry out attacks. In addition, in this step, there is a sub-step to identify vulnerabilities and predisposing conditions that affect the likelihood that threat events of concern result in adverse impacts. The primary purpose of vulnerability assessments is to understand the nature and degree to which organizations, mission/business processes, and information systems are vulnerable to identified threat sources and threat events.

The risk assessment further includes a threat statement. This step is intended to determine the likelihood that threat events of concern result in adverse impacts, considering: (1) the characteristics of the threat sources that could initiate the events; (2) the vulnerabilities/predisposing conditions identified; and (3) the organizational susceptibility reflecting the safeguards/countermeasures planned or implemented to impede such events. The statement further determines the adverse impacts from threat events of concern considering (1) the characteristics of the threat sources that could initiate the events; (2) the vulnerabilities/predisposing conditions identified; and (3) the susceptibility reflecting the safeguards/countermeasures planned or implemented to impede such events.

The user can also create a target profile using the Guide Me Wizard. One again, the target profile requires the user to complete a survey to identify the target Security Environment which can be compared to the user's actual environment as measured by the system. The creation of the target profile is similar to the screens used for the current profile but requires that the user enter aspirational information or is further guided by law, regulation or policy. After the data from the Target Profile has been has been entered, the respective Tier levels are displayed.

Referring now to FIG. 12, as discussed above, each risk is identified by a unique ID number 1210 and categorized in a risk register. The risk register may be grouped. For example the risk may be related to Analysis (AN) 1230, Anomalies and Events (AEE) 12231, Asset Management (AM) 1232, Awareness and Training (AT) 1232. The risk register further provide an indication of the status of the assessment 1050, the probability of the risk occurrence 1051, the level of control 1053 the impact 1054 and the weight 1055.

Also accessible from the dashboard is are Risk Categories in which each of the risks associated with the Identify, Protect, Detect Respond and Recover framework. Also provided is the manner of risk qualification that includes the probability, the impact, the level of control and weight, each of which are defined. For example the probability is described as follows:
10 chances out of 10—extremely likely
9 chances out of 10—most likely
8 chances out of 10—very likely
7 chances out of 10—likely
6 chances out of 10—somewhat likely
5 chances out of 10—even
4 chances out of 10—somewhat unlikely
3 chances out of 10—unlikely
2 chances out of 10—very unlikely
1 chance out of 10—extremely unlike

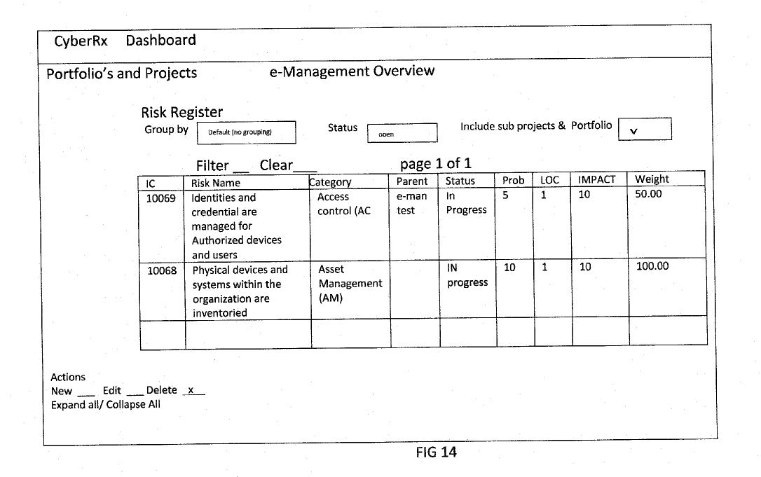

In embodiments, a further function is provided that allows searches of the data relevant to risk. This feature allows the user to search the data by keyword in preselected databases that have been created. For example, a user could search in a Risk ID filed, a Risk Title, and Risk Description. A complete list of fields available in an embodiment is set forth in FIG. 14.

In yet other embodiments the system can be configured to send reminder to the administrator or other designated users to update risk data, to respond to particular risk data deficiencies and to implement action plans.

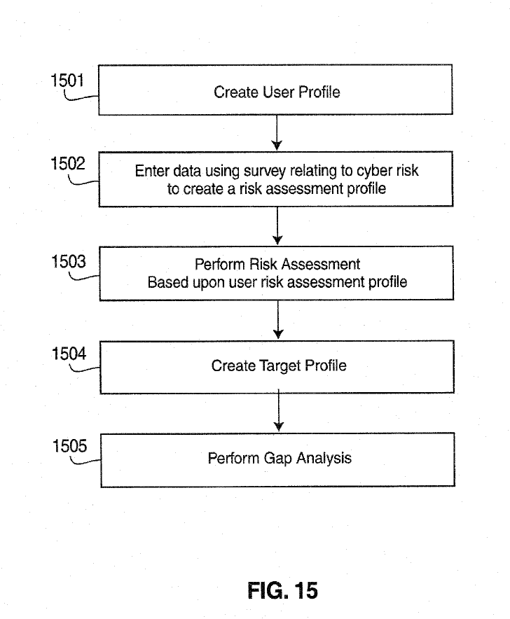

FIG. 15 depicts a flow chart that describes a series of steps of a according an embodiment of the invention that are used in a risk assessment analysis. These steps include, (1) the creation of a user profile 1501, (2) entry of data pursuant to a user a survey relating to cyber risk to create a risk assessment profile 1502, (3) perform a risk assessment based upon the user profile 1503, (4) create a target profile 1504, (5) perform a gap analysis comparing a user profile to the target profile 1505.

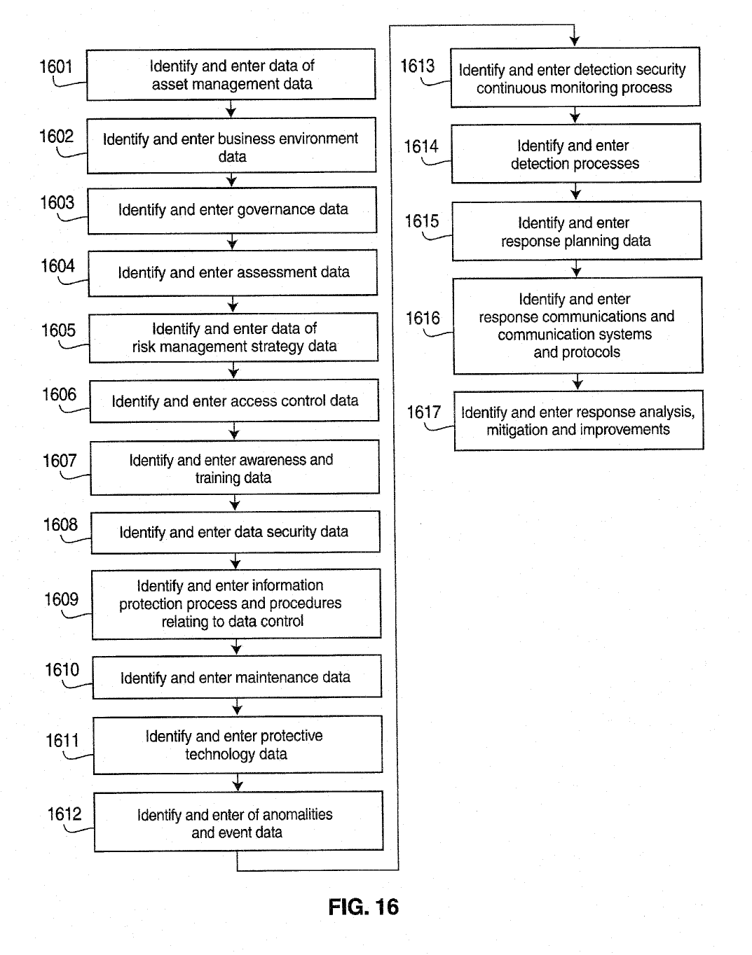

FIG. 16 describes a series of sub-steps involved in step 2 described above and includes the identification and entry data particular to the organization including asset management data 1601, the identification and entry of business environment data 1602, identification and entry of governance data 1603, the identification and entry of risk assessment data 1604, the identification and entry of Risk Management Strategy data 1605, the identification and entry of access control data 1606, the identification and entry of awareness and training data 1607 identification and entry of data security data 1608, the identification and entry of information protection process and procedures relating to data control 1609, the identification and entry of maintenance data 1610, the identification and entry of protective technology data 1611, the identification and entry of anomalies and event data 1612, the identification and entry of detection security continuous monitoring processes 1613, the identification and entry of detection processes 1614, the identification and entry of response planning data 1615, the identification and entry of response communications and communication systems and protocols 1616, the identification and entry of response analysis, mitigation and improvements 1617

In further contemplated embodiments, the system of the invention can be used in conjunction and integrated with automated network analysis tools. The system can use the data collected from automated network analysis stools such as those that relating to system security issues or the detection of software in the assessment analysis. Thus, in a further contemplated embodiment, the system will collect data from network analysis tools relating to network availability, utilization, software, response time, alerts relating to adverse performance, unusual activity based upon historical network usage and user data access. In yet further embodiments, the network can also collect data from external sources relating to network performance, possible threats and the impact of alerts on the overall system. The information collected can then be used by the system to further assess the nature threats, and whether the threats or security breaches are the cause of system downtime.

Referring back to FIG. 2, a dashboard is displayed that includes information relating to an exemplary assessment of a sample organization referred to as an IT Department. The dashboard displays the probability of a breach exposure 109 which was calculated as 47%. The system also calculates and displays the approximate financial liability 110 in terms of costs per record 115 and the cost per cybersecurity breach 116. The display can also provide a “gap analysis” 145 that is described above. Now referring to FIG. 9 a gap analysis is illustrated that includes the assessment of the five categories of the risk assessment system: Identify 901, product 902, detect 903, respond 904 and recover 905. The analysis displays the calculated value in comparison with target values and provide an assessment of the respective tier in which the current assessment falls. Tier 1, Tier 2, Tier 3 and Tier 4. Tier 1 refers to “Risk Informed” meaning that there is an awareness of cybersecurity risk at the organizational level but an organization-wide approach to managing cybersecurity risk has not been established.

In particular, in this Tier 2 Risk Management Process practices are approved by management but may not be established as organizational-wide policy. Prioritization of cybersecurity activities is directly informed by organizational risk objectives, the threat environment, or business/mission requirements.

The integrated risk management program in Tier 2, there is an awareness of cybersecurity risk at the organizational level but an organization-wide approach to managing cybersecurity risk has not been established. Risk-informed, management-approved processes and procedures are defined and implemented, and staff has adequate resources to perform their cybersecurity duties. Cybersecurity information is shared within the organization on an informal basis.

In Tier 2 “External Participation” refers to when the organization knows its role in the larger ecosystem, but has not formalized its capabilities to interact and share information externally.

Tier 3 in general is characterized by a repeatable results. In Tier 3, there is an organization-wide approach to manage cybersecurity risk. Risk-informed policies, processes, and procedures are defined, implemented as intended, and reviewed.

In the Tier 3 the risk management process of the organization management are formally approved and expressed as policy. Such organizational cybersecurity practices are regularly updated based on the application of risk management processes to changes in business/mission requirements and a changing threat and technology landscape.

Tier 3 also requires an organized integrated risk management program. In other words, there is an organization-wide approach to manage cybersecurity risk. Risk-informed policies, processes, and procedures are defined, implemented as intended, and reviewed. Consistent methods are in place to respond effectively to changes in risk. Personnel possess the knowledge and skills to perform their appointed roles and responsibilities.

In addition there is external participation in the third Tier. In this regard, the organization understands its dependencies and partners and receives information from these partners that enables collaboration and risk-based management decisions within the organization in response to events—

Tier 4, the final tier, is referred to as “Adaptive.” At this level, there is an organization-wide approach to managing cybersecurity risk that uses risk-informed policies, processes, and procedures to address potential cybersecurity events.

The risk management process in Tier 4 involves adaption of an organizations cybersecurity practices based on lessons learned and predictive indicators derived from previous and current cybersecurity activities. Through a process of continuous improvement incorporating advanced cybersecurity technologies and practices, the organization actively adapts to a changing cybersecurity landscape and responds to evolving and sophisticated threats in a timely manner.

The integrated risk management program in Tier 4 is characterized by an organization-wide approach to managing cybersecurity risk that uses risk-informed policies, processes, and procedures to address potential cybersecurity events. In this Tier, cybersecurity risk management is part of the organizational culture and evolves from an awareness of previous activities, information shared by other sources, and continuous awareness of activities on their systems and networks.

In Tier 4 there is external participation wherein the organization manages risk and actively shares information with partners to ensure that accurate, current information is being distributed and consumed to improve cybersecurity before a cybersecurity event occurs.

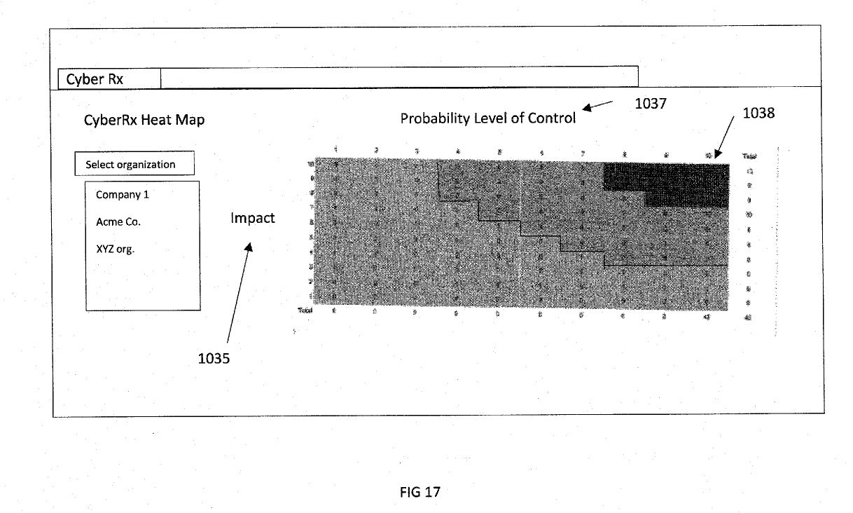

Referring now to FIG. 17, the system can further create a variety of custom reports such as the “Heat Report.” This report displays the number of risks and plots the impact 1035 of the risk on the X axis against the Probability/Level of Control 1037 on the Y axis. The display includes a color coded or uses other distinctive indicia to highlight risks with high impact and high probability. A description of the risks collected in each of the matrixes on the display can be accessed by the activation of a link which directs the user to a report with detailed information relating to each risk that is displayed in the matrix. In preferred embodiments, the display is provide with color coding, so that users can easily identity and research those risks that present the most immediate problems as well as those risks that can easily mitigated.

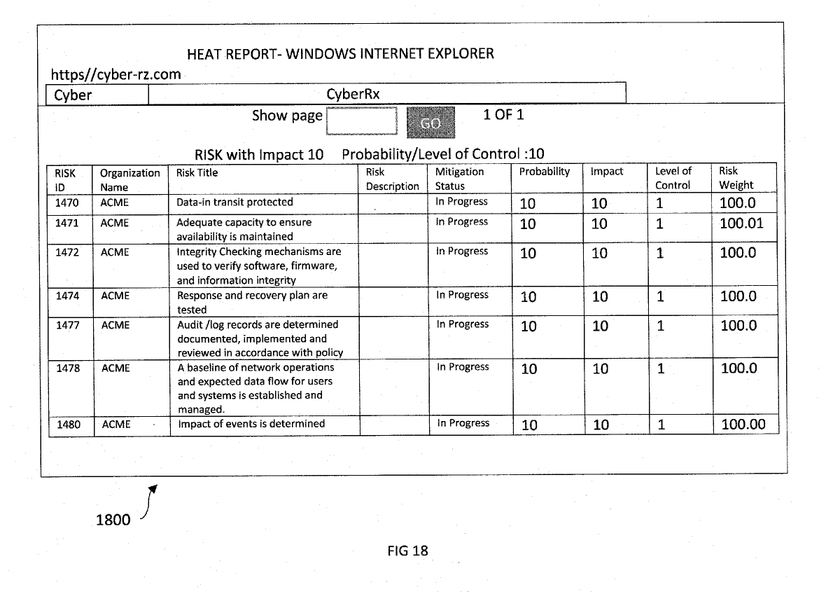

FIG. 18 depicts an exemplary report that is available by accessing a link 1038 provided on the Heat Report wherein the risk impact was evaluated at 10. In this report information relating to the risk is provided including the identification of the risk, the organization that has evaluated the risk, the title of the risk a description of the risk the current mitigation status, the probability of the risk, the impact of the risk, the level of control and risk weight may be viewed.

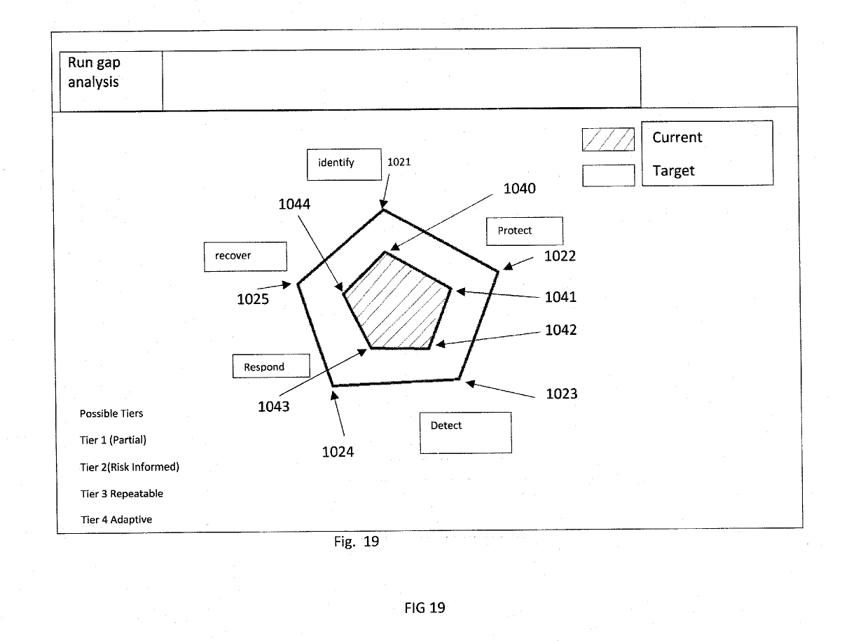

FIG. 19 depicts a display of the gap analysis graphically represented using a pentagon with each of the target objectives 1021, 1022, 1023, 1024 and 1025 occupying the points of a pentagon. The measured achievement values 1040, 1041, 1042. 1053 and 1044 are displayed within the pentagon illustrated by the target values.

As the user enters data into the system, the user can also select values to rate the organization's respective conformance based upon a self-assessment of the impact of a particular risk, the probability of a particular risk and the level of control that the user can exercise over the risk factor. Next, a value is calculated to the particular risk using the following algorithm: probability value x impact value divided by the control equal a risk value. If the user does not select a particular value, the system has a default that uses the threshold risk value that has been previously selected by the user at the initial user interface.

Various algorithms may be used to perform the risk analyses, that provide different weight based upon expert knowledge, historical data, the current cybersecurity climate, such as the nature and extent of related cybersecurity threats. For example, a company operating in an international markets, and in particular competing with Chinese, Russian or Middle Eastern clientele, could select greater weights with respect to the exposure for attack than a company that has sales to limited to the US or only in North America. These values can further be adjusted for particular countries in which the company conducts business. Likewise, if a company does not collect or store particularly sensitive information, such as banking information or medical information, the weight can be appropriately adjusted. The risk assessment values that are calculated using the selected algorithms are then displayed in the gap analysis which divides the divided value into the foregoing tiers to provide further qualitative guidance to those responsible for cybersecurity.

It is to be understood, however, that even though numerous characteristics and advantages of the embodiments have been set forth in the foregoing description, together with details of the methods and manners and functions of embodiment, the disclosure is illustrative only, and changes may be made in detail, especially in the matters of the algorithm determining the evaluation of the assessment of risk in connection with the five categories and the significance of such values.

We claim:

1. A method for the assessment of an entities vulnerability to a cyber attack comprising the steps of:
creating a current profile for the entity based upon selected risk factors;
conducting a risk assessment of said entity based upon said risk assessment profile to create a risk profile which calculates a plurality of risk values;
selecting a target profile based upon said current profile of said entity, said target profile further comprising a target risk profile, said target risk profile further comprising a plurality of values;
comparing said risk profile with said target risk profile;
calculating the differences in said risk values calculated in said risk profile creation step with predetermined values in said target risk profile.

2. The method recited in claim 1 further comprising providing a platform on a computing device to receive input and in responses to said input, providing an output based upon predesignated instructions, said output further comprises a graphic display that includes a representation of values calculated in the risk profile creation step and the target risk profile.

3. The method recited in claim 2 wherein the creation of said profile further comprises the polling a network of devices connected to a private network to assess the number of devices, the status of said devices and characteristics of said devices.

4. The method recited in claim 2 wherein said risk factors comprise, the size of the organization, the laws and regulations that govern the activities of said entity, the relative sensitivity of the information collected and stored by said entity, the physical assets of the entity connected to a network, and information relating to the system's operational status.

5. The method of claim 3 wherein said polling step uses an automated software management tracking software to perform said step.

6. The method of claim 2 further comprising the step of performing a self-assessment step of the impact of a particular risk, wherein a user provides additional data relating to impact of potential risks identified.

7. The method of claim 2 further comprising the step of storing the said current profile in a database comprising a plurality of preexisting target profiles.

8. The method of claim 2 wherein said risk assessment step is performed using an algorithm that assigned weights to categories of risks includes weights selected by expert knowledge, historical data relating to the entity's current profile, and current cybersecurity climate.

9. The method of claim 2 wherein the creation of said current profile further comprises the entry of data relating to asset management, the business environment, the user's governance, the user's risk assessment, the user's risk strategy and said step further comprises the presentation of a survey to assist the user in the identification of relevant data for said assessment.

10. The method of claim 2 wherein said risk value is using the following algorithm: probability value x (times) the impact value divided by the control equal a risk value.

11. A system for the assessment of cybersecurity risk of an entity that operates a network that comprises a database, said database comprising records of a plurality of cybersecurity risk profiles for exemplary target entities, a central processor, said processor adapted to query said database and further adapted to allow user to perform a risk assessment analysis on an application, said application and said processor further in communication with a plurality of assets and adapted to operate automated software management tracking software applications to detect and identify the presence of assets in communication with said network, and adapted to receive input data from said detection and identification application and user created input in said risk assessment application, and a display wherein said display is adapted to display a user interface to allow for the performance of a risk assessment analysis and to display the results of such a risk assessment.
